(19) United States
(12) Patent Application Publication
(10) Pub. No.: US 2013/0037008 A1
(43) Pub. Date: Feb. 14, 2013

(54) PRESSURE WAVE SUPERCHARGER

(71) Applicant: Fumio Takamiya, Gotenba-shi (JP)

(72) Inventor: Fumio Takamiya, Gotenba-shi (JP)

(73) Assignee: TOYOTA JIDOSHA KABUSHIKI KAISHA, Toyota-shi, Aichi-ken (JP)

(21) Appl. No.: 13/125,425

(22) PCT Filed: Apr. 20, 2010
(86) PCT No.: PCT/JP10/56988

§ 371 Date: Apr. 21, 2011

(51) Int. Cl. F02B 33/42; F15B 3/00; F04F 13/00

(52) U.S. Cl. 123/559.2; 417/64

(57) ABSTRACT

The pressure wave supercharger includes a housing having an accommodating room to accommodate a rotor rotatably about an axis, and an exhaust side wall face which is arranged at the accommodating room as being opposed to one end face of the rotor and to which an exhaust gas introduction port and an exhaust gas discharge port are opened, and the rotor includes a shaft portion supported by the housing rotatably about the axis, plural partition walls arranged as being extended in the radial direction from the shaft portion and in the axial direction from the one end face to other end face of the rotor, and a partition member which is arranged at a space between adjacent partition walls and which partitions the space into an inner cell and an outer cell as extending from the one end face to the other end face of the rotor, and an exhaust side groove portion concaved in a direction being apart from the rotor is formed at the exhaust side wall face as being overlapped with a trajectory of the partition member lined during rotation of the rotor as viewed from the axial direction.

### TECHNICAL FIELD

The present invention relates to a pressure wave supercharger to alternately introduce intake air and exhaust gas into cells of a rotor disposed in a housing and to perform supercharging by utilizing pressure waves of exhaust gas introduced into the cells.

### BACKGROUND ART

There is known a pressure wave supercharger in which a rotor having plural cells is rotatably arranged in a housing to alternately introduce intake air and exhaust gas into the cells and to perform supercharging to an internal combustion engine as pressurizing intake air in the cells by the introduced exhaust gas. In the pressure wave supercharger, since exhaust gas is introduced into the housing, the housing and the rotor are elongated due to heat of exhaust gas. Accordingly, there is known a pressure wave supercharger having a rotor made of ceramic of which thermal expansion coefficient is small (see Patent Document 1). In addition, Patent Document 2 is another prior art document related to the present invention.

### CITATION LIST

### Patent Literature

Patent Document 1: JP-01-159418A
Patent Document 2: JP-04-019327A

### SUMMARY OF THE INVENTION

### Technical Problem

There is known a rotor for pressure wave supercharger in which plural spaces are formed around a shaft portion as penetrating in an axial direction by radially disposing plural partition walls extending in a radial direction from the shaft portion rotatably supported by a housing and in which plural cells are formed by partitioning each space into an inner circumferential side and an outer circumferential side respectively with a partition member. When exhaust gas is introduced into each cell of such a rotor, the partition member is heated from both sides being the inner circumferential side and the outer circumferential side. Then, temperature of the partition member becomes higher than that of other sections of the rotor and there is possibility that the partition member protrude from an end face of the rotor. In this case, when clearance between the rotor and the hosing is small, there is a possibility that the partition member is contacted with the housing. On the other hand, when largeness of the clearance between the rotor and the housing is sufficiently ensured so that the partition member expanded due to heat is not contacted with the housing, there is a possibility that a supercharging efficiency is decreased due to increase of quantity of intake air and exhaust gas leaking between the rotor and the housing.

In view of the foregoing, one object of the present invention is to provide a pressure wave supercharger capable of preventing contacting between a rotor and a housing while suppressing decrease of a supercharging efficiency.

### Solution to Problem

A pressure wave supercharger according to a first aspect of the present invention includes a housing having an accommodating room to accommodate a rotor rotatably about an axis, and an exhaust side wall face which is arranged at the accommodating room as being opposed to one end face of the rotor in the axial direction and to which an exhaust gas introduction port and an exhaust gas discharge port communicating with an exhaust passage of an internal combustion engine are opened; wherein the rotor includes a shaft portion supported by the housing rotatably about the axis, plural partition walls arranged as being extended in the radial direction from the shaft portion and in the axial direction from the one end face to the other end face of the rotor, and a partition member which is arranged at a space between mutually adjacent partition walls and which partitions the space into an inner cell at an inner circumferential side and an outer cell at an outer circumferential side as extending from the one end face to the other end face of the rotor; and a groove portion concaved in a direction being apart from the rotor is formed at the exhaust side wall face as being overlapped with a trajectory of the partition member lined during rotation of the rotor as viewed from the axial direction.

According to the first pressure wave supercharger of the present invention, the groove portion is formed at the exhaust side wall face so as to be overlapped with the trajectory of the partition member lined during rotation of the rotor, that is, so as to be opposed to the partition member. Accordingly, even when the partition member protrudes from the one end face of the rotor due to heat expansion, contacting of the protruded part with the exhaust side wall face can be prevented by appropriately arranging the width of the groove portion. Further, by arranging the groove portion as described above, largeness of clearance between the one end face of the rotor and the exhaust side wall face can be set without considering protruding length of the partition member from the rotor at the time of heat expansion. Accordingly, the largeness of the clearance between the one end face of the rotor and the exhaust side wall face can be reduced. With this configuration, since quantity of exhaust gas leaking between the housing and the rotor can be reduced, decrease of supercharging efficiency can be suppressed. Hence, according to the first pressure wave supercharger, contacting between the rotor and the housing can be prevented while suppressing decrease of the supercharging efficiency.

In one embodiment of the first pressure wave supercharger according to the present invention, the groove portion may be formed at the exhaust side wall face so that width thereof is equal to or larger than thickness of the partition member in the radial direction. By setting the width of the groove portion as described above, contacting of the partition member with the exhaust side wall face can be prevented further reliably.

In one embodiment of the first pressure wave supercharger according to the present invention, the housing may further include an intake side wall face which is arranged at the accommodating room as being opposed to the other end face of the rotor and to which an intake air introduction port and an intake air discharge port communicating with an intake passage of the internal combustion engine are opened; and an intake side groove portion concaved in a direction being apart from the rotor is formed at the intake side wall face as being overlapped with a trajectory of the partition member lined during rotation of the rotor as viewed from the axial direction. According to this embodiment, even when the partition member is protruded from the other end face of the rotor due to heat expansion, contacting of the protruded part with the intake side wall face can be prevented. Therefore, contacting between the rotor and the housing can be further prevented.

In this embodiment, the intake side groove portion may be formed at the intake side wall face so that width thereof is equal to or larger than thickness of the partition member in the radial direction. By setting the width of the intake side groove portion as described above, contacting of the partition member with the intake side wall face can be prevented further reliably.

A pressure wave supercharger according to a second aspect of the present invention includes a housing having an accommodating room to accommodate a rotor rotatably about an axis, and an exhaust side wall face which is arranged at the accommodating room as being opposed to one end face of the rotor in the axial direction and to which an exhaust gas introduction port and an exhaust gas discharge port communicating with an exhaust passage of an internal combustion engine are opened; wherein the rotor includes a shaft portion supported by the housing rotatably about the axis, plural partition walls arranged as being extended in the radial direction from the shaft portion and in the axial direction from the one end face to the other end face of the rotor, and a partition member which is arranged at a space between mutually adjacent partition walls to partition the space into an inner cell at an inner circumferential side and an outer cell at an outer circumferential side; and the partition member is disposed at the rotor so that an end thereof at the one end face side is arranged at a position being further apart from the exhaust side wall face than the one end face.

According to the second pressure wave supercharger of the present invention, since an end of the partition member at the one end face side, that is, an end of the exhaust side, is arranged at a position being further apart from the exhaust side wall face than the one end face of the rotor, protruding of the partition member from the one end face of the rotor can be suppressed even when the partition member is elongated due to heat expansion in the axial direction. Accordingly, contacting of the partition member with the exhaust side wall face can be suppressed. Further, by appropriately setting the position of the end of the partition member at the one end face side, protruding of the partition member from the one end face of the rotor can be prevented even when the partition member is elongated in the axial direction due to heat expansion. Accordingly, largeness of a clearance between the one end face of the rotor and the exhaust side wall face can be reduced. With this configuration, since quantity of exhaust gas leaking between the housing and the rotor can be reduced, decrease of supercharging efficiency can be suppressed. Hence, contacting between the rotor and the housing can be prevented while suppressing decrease of the supercharging efficiency.

In one embodiment of the second pressure wave supercharger according to the present invention, the housing may further include an intake side wall face which is arranged at the accommodating room as being opposed to the other end face of the rotor and to which an intake air introduction port and an intake air discharge port communicating with an intake passage of the internal combustion engine are opened; and the partition member may be disposed so that an end thereof at the other end face side is arranged at a position being further apart from the intake side wall face than the other end face. In this case, protruding of the partition member from the other end face of the rotor can be suppressed even when the partition member is elongated due to heat expansion in the axial direction. Accordingly, since protruding of the partition member from the other end face of the rotor can be suppressed, contacting between the rotor and the housing can be further prevented.

### BRIEF DESCRIPTION OF THE DRAWINGS

FIG. 1 is a view showing an internal combustion engine in which a pressure wave supercharger according to a first embodiment of the present invention is incorporated.

FIG. 2 is an enlarged view of the pressure wave supercharger.

FIG. 3 is a cross section view of a rotor taken along the line III-III in FIG. 2.

FIG. 4 is a cross section view of the pressure wave supercharger taken along the line IV-IV in FIG. 2.

FIG. 5 is a cross section view of the pressure wave supercharger taken along the line V-V in FIG. 2.

FIG. 6 is a cross section view of the pressure wave supercharger taken along the line VI-VI in FIG. 4.

FIG. 7 is a view showing one end face of the rotor and an exhaust side wall face when the engine is operated at full load.

FIG. 8 is a view showing one end face of a rotor and an exhaust side wall face when the engine is operated at full load with a pressure wave supercharger without having an exhaust side groove portion.

FIG. 9 is a view of a part of a pressure wave supercharger according to a second embodiment of the present invention.

FIG. 10 is a view showing an exhaust side wall face of the pressure wave supercharger according to the second embodiment.

### DESCRIPTION OF EMBODIMENTS

### First Embodiment

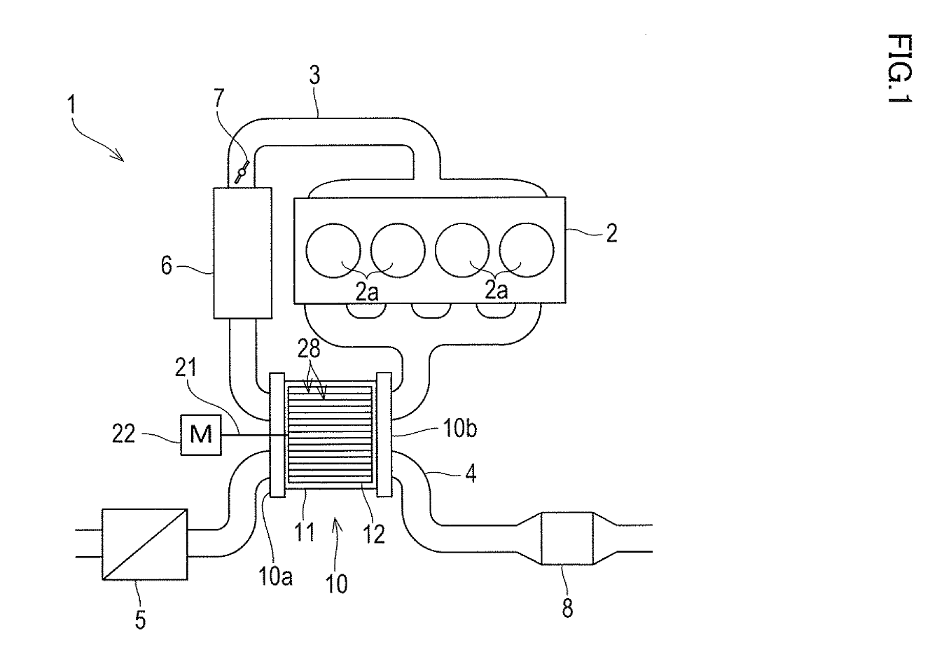

FIG. 1 shows an internal combustion engine in which a pressure wave supercharger according to a first embodiment of the present invention is incorporated. The internal combustion engine (also referred as engine, hereinafter) 1 is mounted on a vehicle as a driving power source. The internal combustion engine 1 includes an engine main body 2 having plural cylinders 2a (here, four cylinders in FIG. 1). An intake passage 3 and an exhaust passage 4 are connected to each cylinder 2a. As shown in FIG. 1, the intake passage 3 is provided with an air cleaner 5 for filtering intake air, an intake side end portion 10a of a pressure wave supercharger 10, an intercooler 6 for cooling intake air, and a throttle valve 7 for regulating intake gas amount, in the order from the upstream side of the intake air flow direction. The exhaust passage 4 is provided with an exhaust side end portion 10b of the pressure wave supercharger 10 and an exhaust gas purifier 8 to purify exhaust gas, in the order from the upstream side of the exhaust gas flow direction.

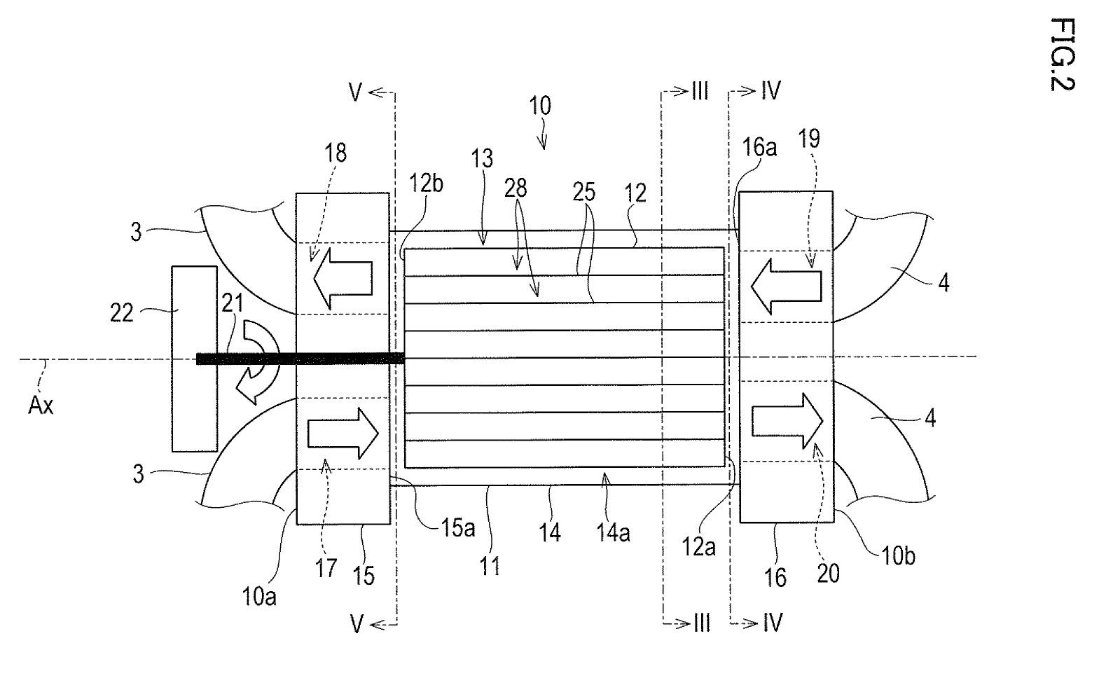

FIG. 2 is an enlarged view of the pressure wave supercharger 10. The pressure wave supercharger 10 includes a housing 11 and a rotor 12. A hollow cylindrical accommodating room 13 extending in the direction of an axis Ax is formed at the inside of the housing 11. The rotor 12 is accommodated in the accommodating room 13 as being rotatable about the axis Ax. The housing 11 includes a rotor housing 14, an intake side attachment 15 to be the intake side end portion 10a as being attached to one end of the rotor housing 14, and an exhaust side attachment 16 to be the exhaust side end portion 10b as being attached to the other end of the rotor housing 14. The rotor housing 14 is formed with a hollow cylindrical space 14a as being penetrated in the direction of the axis Ax from the one end to the other end thereof. The accommodating room 13 is formed by closing both ends of the space 14a with the intake side attachment 15 and the exhaust side attachment 16. The intake side attachment 15 is provided with an intake air introduction port 17 and an intake air discharge port 18. The intake air introduction port 17 connects the inside of the accommodating room 13 and a section of the intake passage 3 at the upstream side from the pressure wave supercharger 10 in the intake air flow direction. The intake air discharge port 18 connects the inside of the accommodating room 13 and a section of the intake passage 3 at the downstream side from the pressure wave supercharger 10 in the intake air flow direction. The exhaust side attachment 16 is provided with an exhaust gas introduction port 19 and an exhaust gas discharge port 20. The exhaust gas introduction port 19 connects the inside of the accommodating room 13 and a section of the exhaust passage 4 at the upstream side from the pressure wave supercharger 10 in the exhaust gas flow direction. The exhaust gas discharge port 20 connects the inside of the accommodating room 13 and a section of the exhaust passage 4 at the downstream side from the pressure wave supercharger 10 in the exhaust gas flow direction.

The pressure wave supercharger 10 includes a shaft 21 supported by the housing 11 as being rotatable about the axis Ax. The shaft 21 is located on the axis Ax. The rotor 12 is attached to one end of the shaft 21 to be rotated integrally therewith. The other end of the shaft 21 is connected to an output shaft of an electric motor 22. Thus, the rotor 12 is rotated by the electric motor 22.

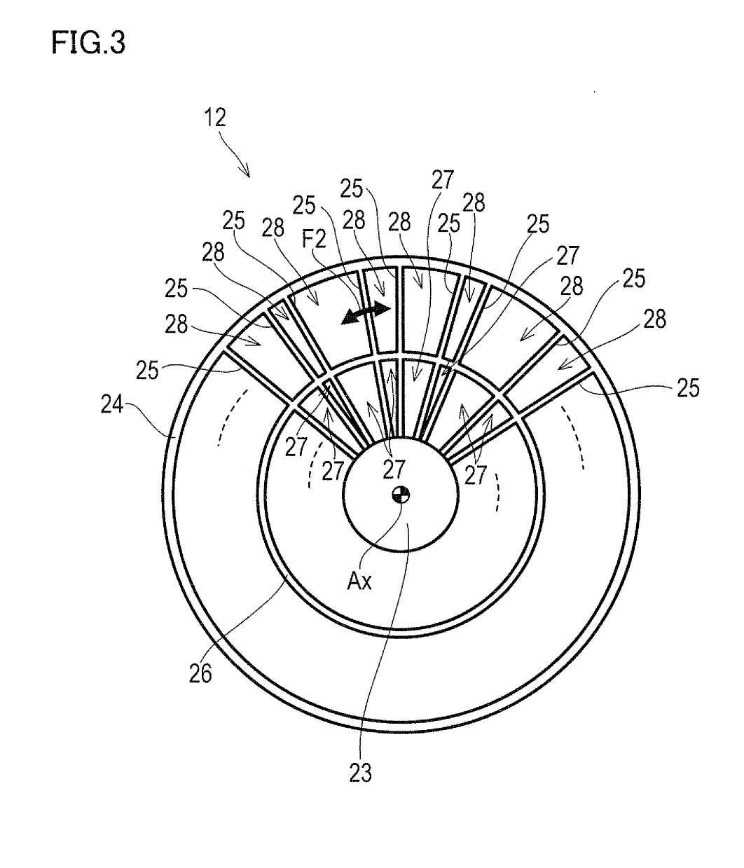

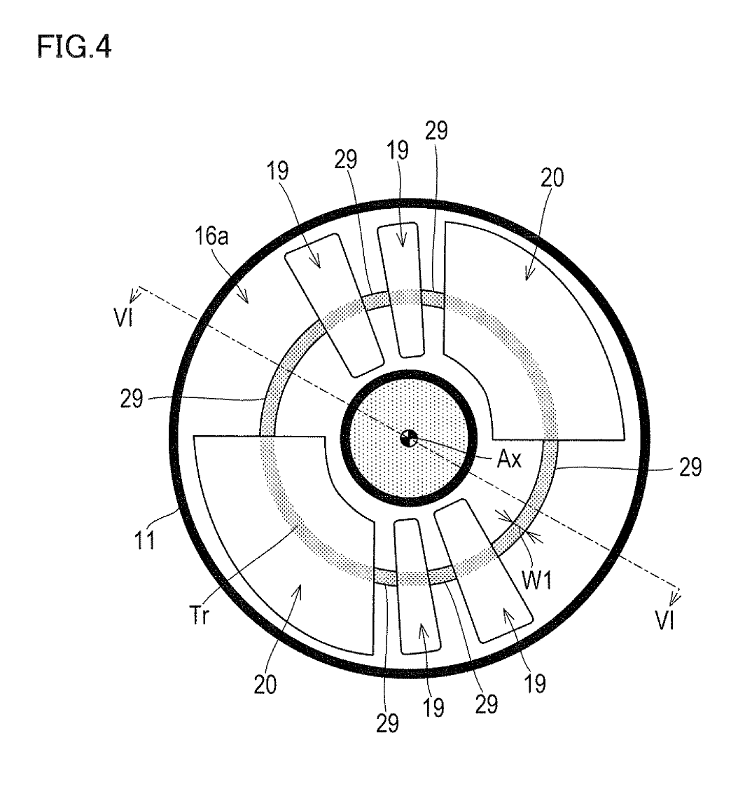

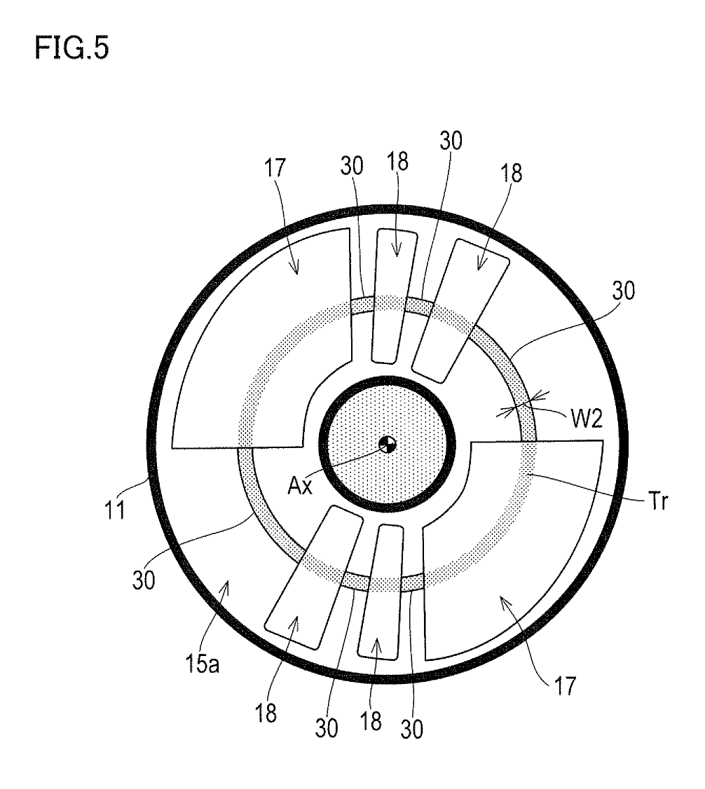

FIG. 3 is a cross sectional view of the rotor 12 taken along the line in FIG. 2. FIG. 4 is a cross sectional view of the pressure wave supercharger 10 taken along the line IV-IV in FIG. 2. FIG. 5 is a cross sectional view of the pressure wave supercharger 10 taken along the line V-V in FIG. 2. As shown in FIG. 3, the rotor 12 includes a shaft portion 23 to be connected to the shaft 21 and a cylindrical outer cylinder 24 being an outer circumferential face of the rotor 12. The shaft portion 23 and the outer cylinder 24 are arranged coaxially. Plural partition walls 25 extending from the shaft portion 23 in the radial direction are arranged along the whole circumference between the shaft portion 23 and the outer cylinder 24. The plural partition walls 25 are arranged in the circumferential direction at intervals. Further, the plural partition walls 25 are arranged as being extended in the direction of the axis Ax from one end face 12a to other end face 12b of the rotor 12. As shown in this figure, a partition member 26 is disposed at each space between mutually adjacent partition walls 25. The partition member 26 is arranged so as to partition the space between the partition walls 25 into an inner cell 27 at the inner circumferential side and an outer cell 28 at the outer circumferential side. Similarly to the partition walls 25, the partition member 26 is arranged as being extended in the axial direction from the one end face 12a to the other end face 12b of the rotor 12. As shown in this figure, each partition member 26 is arranged to be aligned concyclically having the axis Ax as the center thereof viewing the rotor 12 from the axial direction. That is each partition member 26 is arranged so as to form a cylinder having the axis Ax as the center thereof. In this manner, by forming the plural partition walls 25 and the partition member 26, the plural cells 27, 28 penetrating in the direction of the axis Ax are formed at the rotor 12.

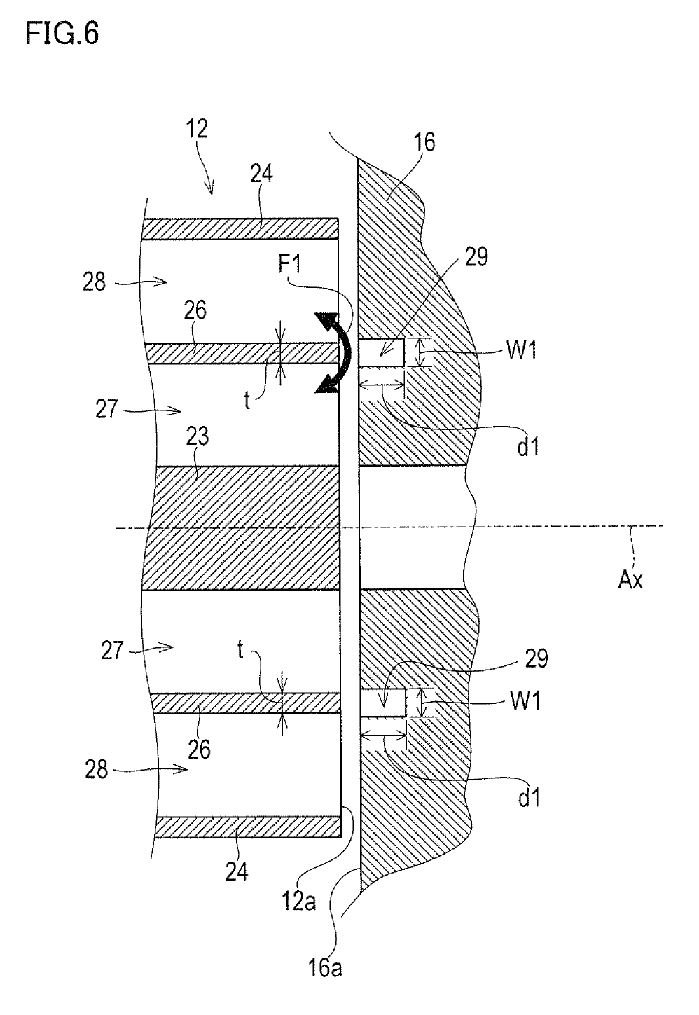

As shown in FIG. 4, the exhaust side attachment 16 is provided with an exhaust side wall face 16a opposed to the one end face 12a of the rotor 12. As shown in this figure, the exhaust gas introduction port 19 and the exhaust gas discharge port 20 are opened to the exhaust side wall face 16a. Further, an exhaust side groove portion 29 is formed at the exhaust side wall face 16a as a groove portion concaved in the direction being apart from the rotor 12 along the axis Ax. The exhaust side groove portion 29 is formed as being overlapped with a trajectory Tr of the partition member 26 lined during rotation of the rotor 12 as viewed from the direction of the axis Ax. That is, the exhaust side groove portion 29 is formed to be opposed to the partition member 26. FIG. 6 is a cross sectional view of the pressure wave supercharger 10 taken along the line VI-VI in FIG. 4. Here, this figure shows the pressure wave supercharger 10 as each part of the rotor 12 is not elongated in the direction of the axis Ax due to heat of exhaust gas. As shown in this figure, the exhaust side groove portion 29 is formed so that the width W1 thereof is equal to or larger than the thickness t of the radial direction of the partition member 26. The depth d1 of the exhaust side groove portion 29 is set corresponding to largeness of elongation due to heat in the direction of the axis Ax of the partition member 26 occurring when the engine 1 is operated at full load, that is, when exhaust gas temperature is the highest. For example, in the case that the partition member 26 is elongated by approximate 0.4 mm in the direction of the axis Ax when the engine 1 is operated at full load, the depth d1 of the exhaust side groove portion 29 is set to be 0.5 mm.

As shown in FIG. 5, the intake side attachment 15 is provided with an intake side wall face 15a opposed to the other end face 12b of the rotor 12. As shown in this figure, the intake air introduction port 17 and the intake air discharge port 18 are opened to the intake side wall face 15a. Further, similarly to the exhaust side wall face 16a, an intake side groove portion 30 is formed also at the intake side wall face 15a concaved in the direction being apart from the rotor 12 along the direction of the axis Ax. The intake side groove portion 30 is formed as being overlapped with a trajectory Tr of the partition member 26 lined during rotation of the rotor 12 as viewed from the direction of the axis Ax. That is, the intake side groove portion 30 is also formed to be opposed to the partition member 26 as being similar to the exhaust side groove portion 29. The intake side groove portion 30 is formed so that the width W2 thereof is equal to or larger than the thickness t in the radial direction of the partition member 26. Further, the depth of the intake side groove portion 30 is set corresponding to the largeness of elongation due to heat in the direction of the axis Ax of the partition member 26 occurring when the engine 1 is operated at full load.

As well known, the pressure wave supercharger 10 introduces exhaust gas into each cell 27, 28 from the exhaust passage 4 by rotating the rotor 12 and pressurizes intake air in each cell 27, 28 by utilizing pressure waves of the exhaust gas. Then, supercharging to the engine 1 is performed by supplying the pressurized intake air to the cylinders 2a. In this manner, since exhaust gas is introduced into each cell 27, 28 in the pressure wave supercharger 10, the exhaust gas heats the shaft portion 23, the outer cylinder 24, the partition walls 25, and the partition member 26. Among the above, the shaft portion 23 contacts to the exhaust gas only at the outer circumferential side thereof and the outer cylinder 24 contacts to the exhaust gas only at the inner circumferential side thereof. Accordingly, temperature difference occurs between the inner circumferential side and the outer circumferential side respectively with the shaft portion 23 and the outer cylinder 24 and heat moves toward the side of which temperature is lower. Further, since the partition walls 25 are connected to the shaft portion 23 and the outer cylinder 24, heat moved to the shaft portion 23 and the outer cylinder 24. Therefore, the shaft portion 23, the outer cylinder 24 and the partition walls 25 are respectively elongated in the direction of the axis Ax in an approximate similar manner due to heat expansion. Meanwhile, the partition member 26 contacts to the exhaust gas at both sides being the inner circumferential side and the outer circumferential side thereof and is connected only to the partition walls 25. Hence, heat is difficult to move from the partition member 26 to the outside compared to the other parts of the rotor 12. Accordingly, temperature of the partition member 26 becomes higher than that of the other parts of the rotor 12, so that temperature difference occurs thereamong. In this case, elongation due to heat in the direction of the axis Ax of the partition member 26 becomes larger than elongation due to heat in the direction of the axis Ax of the other parts. Then, the partition member 26 protrudes in the direction of the axis Ax from the one end face 12a of the rotor 12.

In the pressure wave supercharger 10 of the first embodiment, since the exhaust side groove portion 29 is formed at the exhaust side wall face 16a, it is possible to prevent contacting of the partition member 26 with the exhaust side wall face 16a even when the partition member 26 protrudes from the one end face 12a. In addition, since the intake side groove portion 30 is formed at the intake side wall face 15a, it is possible to prevent contacting of the partition member 26 with the intake side wall face 15a even when the partition member 26 protrudes from the other end face 12b of the rotor 12 due to heat expansion.

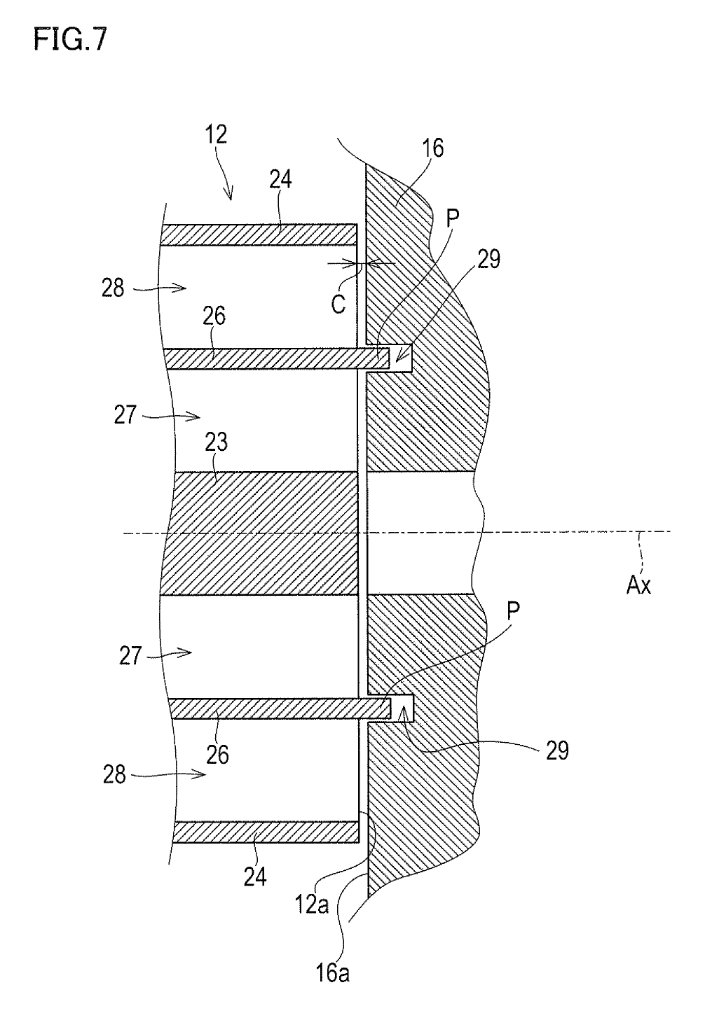

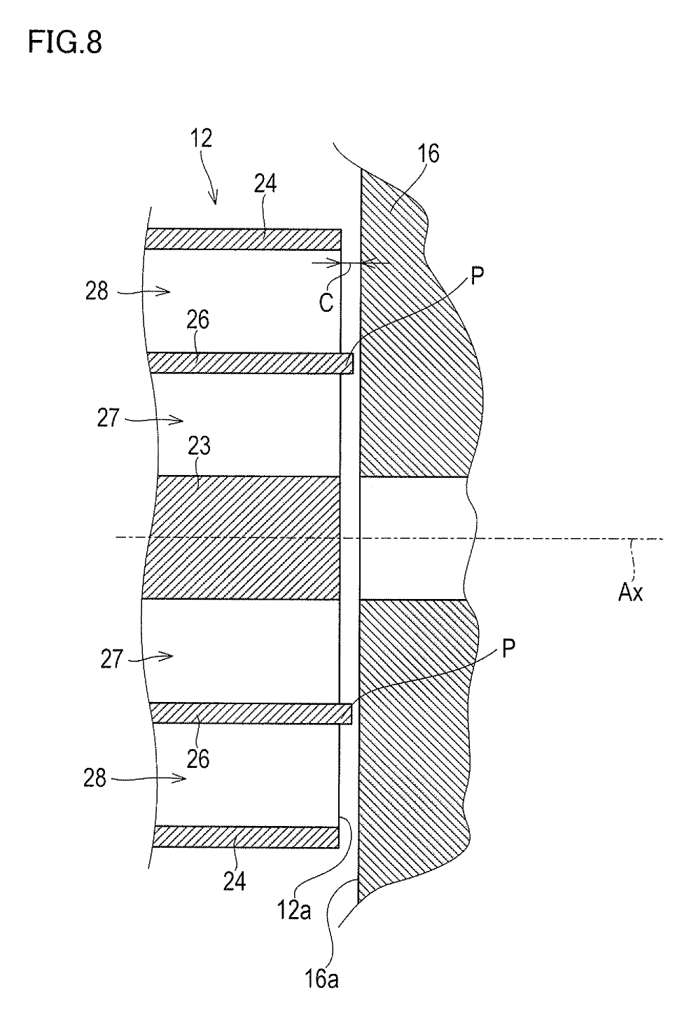

Next, a method to set largeness of clearance C between the one end face 12a of the rotor 12 and the exhaust side wall face 16a will be described with reference to FIGS. 7 and 8. Here, FIG. 7 shows the one end face 12a of the rotor 12 and the exhaust side wall face 16a of the pressure wave supercharger 10 when the engine 1 is operated at full load. FIG. 8 shows the one end face 12a of the rotor 12 and the exhaust side wall face 16a of a pressure wave supercharger without having the exhaust side groove portion 29 when the engine 1 is operated at full load. The largeness of the clearance C between the one end face 12a of the rotor 12 and the exhaust side wall face 16a (hereinafter, referred as clearance C) is set so that the rotor 12 is not contacted with the housing 11 at the time of full-load operation of the engine 1. Accordingly, in the case without the exhaust side groove portion 29 as shown in FIG. 8, the largeness of the clearance C is required to be set in consideration of a part P of the partition member 26 protruding from the one end face 12a of the rotor 12. Since the clearance C further becomes larger when the engine 1 is operated at partial load, the supercharging efficiency is decreased as quantity of exhaust gas leaking between the housing 11 and the rotor 12 is increased.

On the other hand, in the pressure wave supercharger 10 of the first embodiment, since the exhaust side groove portion 29 is provided, the largeness of the clearance C can be set without considering the protruding part P as shown in FIG. 7. Accordingly, the largeness of the clearance C can be set so that the clearance C is arranged as shown in this figure at the time of full-load operation of the engine 1 as the clearance C being the minimum thereat. Therefore, the largeness of the clearance C can be reduced compared to the case without the exhaust side groove portion 29. In this case, since the clearance C can be reduced also when the engine 1 is operated at partial load, quantity of exhaust gas leaking between the housing 11 and the rotor 12 can be reduced. Accordingly, decrease of the supercharging efficiency can be suppressed. In addition, since the intake side groove portion 30 is formed at the intake side wall face 15a in the pressure wave supercharger 10, largeness between the other end face 12b of the rotor 12 and the intake side wall face 15a can be reduced for the similar reason to the above. Here, the description thereof is not repeated here.

In the pressure wave supercharge 10, exhaust gas is moved between each inner cell 27 and each outer cell 28 aligned in the radial direction via the exhaust side groove portion 29 as indicated by arrow F1 in FIG. 6. The exhaust gas introduced to the cells 27, 28 aligned in the radial direction is introduced from the exhaust passage 4 at the same timing. Therefore, even when the exhaust gas is moved between the cells 27, 28, there is little influence to the pressurization of intake air and the supercharging efficiency is not decreased. Although intake air is moved between the cells 27, 28 via the intake side groove portion 30 at the intake side as well, the supercharging efficiency is not decreased for the similar reason to the exhaust side. On the contrary, it is possible to suppress movement of exhaust gas or intake air between the cells adjacent to each other in the circumferential direction as illustrated by arrow F2 in FIG. 3. Since the timing of introduction of exhaust gas or intake air mutually differs between the cells adjacent to each other in the circumferential direction, the supercharging efficiency is decreased when movement of exhaust gas or intake air occurs therebetween. In the pressure wave supercharger 10 of the present invention, since such movement of exhaust gas and intake air can be suppressed, decrease of the supercharging efficiency can be suppressed.

As described above, according to the pressure wave supercharger 10 of the first embodiment, since the exhaust side groove portion 29 and the intake side groove portion 30 are provided, contacting between the rotor 12 and the housing 11 can be prevented while suppressing decrease of the supercharging efficiency.

The width W1 of the exhaust side groove portion 29 and the width W2 of the intake side groove portion 30 may be set at a value larger than the thickness t of the partition member 26 in consideration of vibration during rotation of the rotor 12. In this case, contacting of the rotor 12 with the housing 11 can be prevented even when the rotor 12 is vibrated.

Here, in the pressure wave supercharger 10 according to this embodiment, the intake side groove portion 30 may be eliminated. Since intake air is introduced from the intake passage 3 to a part of the intake side of the rotor 12, a part of the intake side of the partition member 26 is cooled with the intake air. Therefore, elongation of the partition member 26 toward the intake side is smaller than that toward the exhaust side. Accordingly, the intake side groove portion 30 can be eliminated. In this case, since machining operation for the intake side groove portion 30 can be eliminated, manufacturing cost can be reduced.

### Second Embodiment

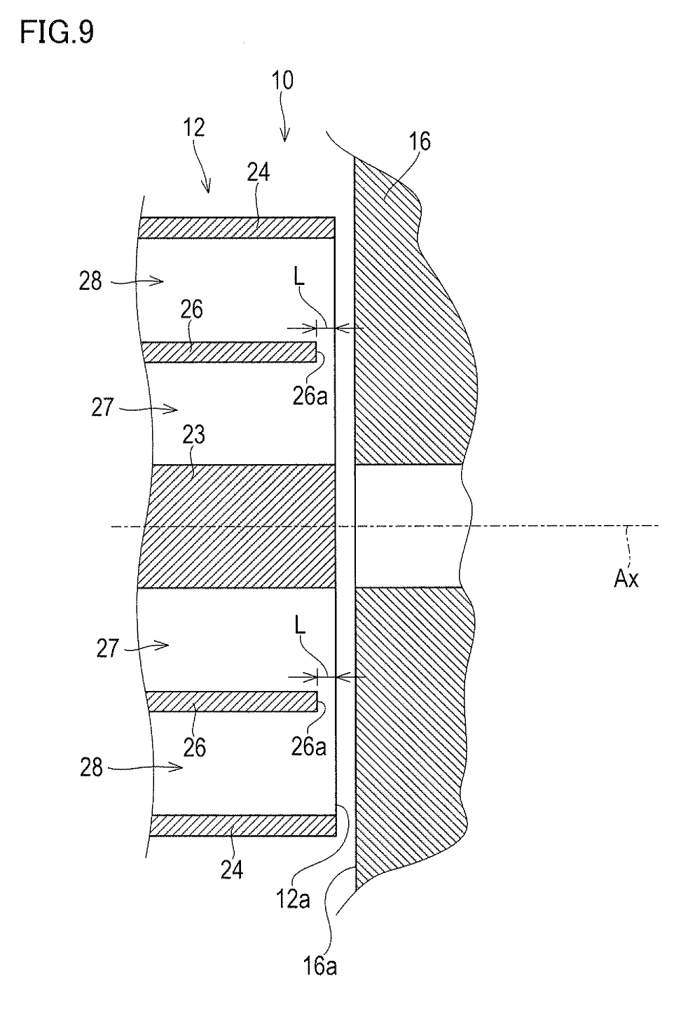

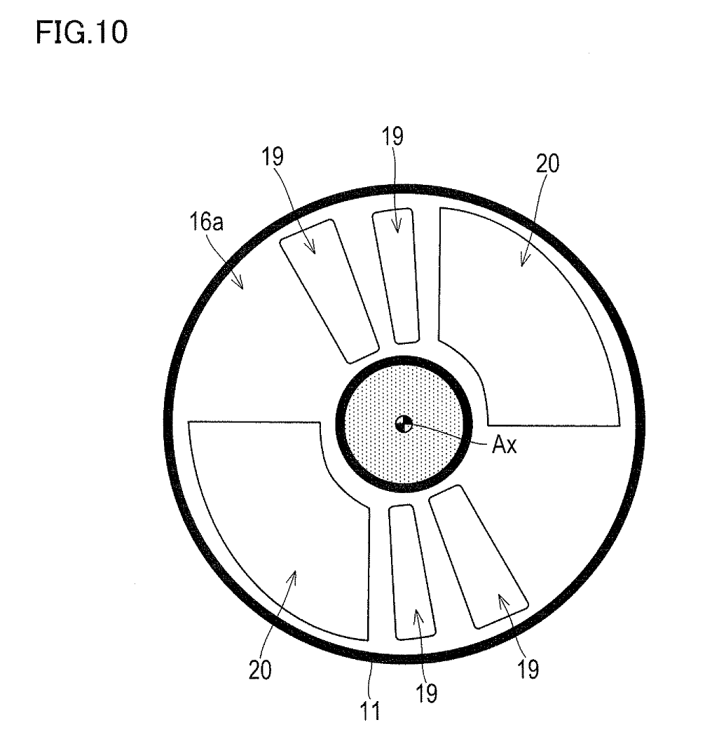

Next, a pressure wave supercharger 10 according to a second embodiment of the present invention will be described with reference to FIGS. 9 and 10. FIG. 9 is an enlarged view of a part of the pressure wave supercharger 10 according to the present embodiment. FIG. 10 shows an exhaust side wall face 16a of the pressure wave supercharger 10 of the present embodiment. In the present embodiment, only a rotor 12, the exhaust side wall face 16a and an intake side wall face 15a are different from those of the first embodiment and the rest thereof is the same as that of the first embodiment. Therefore, the same components as those in the first embodiment are denoted by the same reference numeral, and descriptions thereof will be omitted.

FIG. 9 is a view corresponding to FIG. 6 for the first embodiment and shows one end face 12a of the rotor 12 in an enlarged manner. That is, this figure shows the pressure wave supercharger 10 as each part of the rotor 12 is not elongated in the direction of the axis Ax due to heat of exhaust gas. As shown in this figure, in the present embodiment, the partition member 26 is disposed at the rotor 12 so that an end 26a of the partition member 26 at the one end side is arranged to be further apart from the exhaust side wall face 16a than the one end face 12a in the direction of the axis Ax. That is, the end 26a of the partition member 26 at the one end side is arranged at a position being inner side than the one end face 12a. Distance L between the end 26a at the one end side and the one end face 12a is set corresponding to largeness of elongation due to heat in the direction of the axis Ax of the partition member 26 occurring when the engine 1 is operated at full load. For example, the distance L is set so that the end 26a at the one end side is to be flush with the one end face 12a when the engine 1 is operated at full load. Further, although it is not shown, an end of the partition member 26 at the other end side is arranged at a position to be further apart from the intake side wall face 15a than the other end face 12b as well. Then, distance between the end at the other end side and the other end face 12b is also set corresponding to the largeness of elongation due to heat in the direction of the axis Ax of the partition member 26.

Further, in the present embodiment, the exhaust side groove portion 29 is not formed at the exhaust side wall face 16a as shown in FIGS. 9 and 10. Although it is not shown, the intake side groove portion 30 is not formed at the intake side wall face 15a as well.

In the present embodiment, since the end 26a of the partition member 26 at the one end side is arranged to be further apart from the exhaust side wall face 16a than the one end face 12a as shown in FIG. 9, it is possible to prevent contacting of the partition member 26 with the exhaust side end face 16a at the time of full-load operation of the engine 1. Similarly, since the end of the partition member 26 at the other end side is arranged to be further apart from the intake side wall face 15a than the other end face 12b, it is possible to prevent contacting of the partition member 26 with the intake side wall face 15a at the time of full-load operation of the engine 1.

Further, in the present embodiment, since both ends of the partition member 26 do not protrude from the end faces 12a, 12b of the rotor 12 even when the engine 1 is operated at full load, largeness of the clearance between each end face 12a, 12b of the rotor 12 and the housing 11 at the time of full-load operation of the engine 1 can be reduced. Further, largeness of the clearance between the rotor 12 and the housing 11 at the time of partial-load operation of the engine 1 can be also reduced thereby. Accordingly, quantity of intake air and exhaust gas leaking between the housing 11 and the rotor 12 can be respectively reduced. Therefore, decrease of the supercharging efficiency can be suppressed.

Here, in the pressure wave supercharger 10, it is also possible that the end of the partition member 26 at the other end side, that is, the intake side, is arranged to be flush with the other end face 12b of the rotor 12 in a state that the partition member 26 is not elongated due to heat. As described above, the part of the intake side of the partition member 26 is cooled by the intake air, elongation thereof due to heat in the direction of the axis Ax is small. Accordingly, even when the end of the partition member 26 at the other end side is formed flush with the other end face 12b of the rotor 12, contacting of the rotor 12 with the housing 11 can be prevented.

The prevent invention is not limited to the above-described embodiments, and may be embodied in various form. For example, the rotor disposed at the pressure wave supercharger of the present invention is not limited to the rotor in which a space between partition walls is partitioned into two layers. For example, it is also possible to adopt a rotor having a space between partition walls being partitioned into three or more layers in the radial direction as disposing two or more partition members between the partition walls. In this case, an exhaust side groove portion is respectively formed at the exhaust side wall surface of the housing as being overlapped with a trajectory of each partition member lined during rotation of the rotor as viewed from the axial direction. Further, it is also possible to adopt a rotor of which partition members are disposed at positions being alternately shifted in the radial direction for every adjacent space between partition walls. Further, it is also possible to adopt a rotor of which partition members are disposed only at a part of spaces between partition walls. In these cases as well, it is only required to form the exhaust side groove portion at the exhaust side wall face to be overlapped with a trajectory of the partition members during rotation of the rotor. An intake side groove portion may be formed at the intake side wall face as being similar to the exhaust side groove portion.

In each embodiment describe above, the rotor is rotated by an electric motor. However, the drive source is not limited to an electric motor. For example, it is also possible to rotationally drive the rotor by utilizing rotation of a crank shaft of an internal combustion engine. In this case, it is also possible to change rotational speed of the rotor by disposing a transmission mechanism at a power transmission route between the crank shaft and the rotor.

1. A pressure wave supercharger comprising:
a housing including an accommodating room to accommodate a rotor rotatably about an axis, and an exhaust side wall face which is arranged at the accommodating room as being opposed to one end face of the rotor in the axial direction and to which an exhaust gas introduction port and an exhaust gas discharge port communicating with an exhaust passage of an internal combustion engine are opened;
wherein the rotor includes a shaft portion supported by the housing rotatably about the axis, plural partition walls arranged as being extended in the radial direction from the shaft portion and in the axial direction from the one end face to other end face of the rotor, and a partition member which is arranged at a space between mutually adjacent partition walls and which partitions the space into an inner cell at an inner circumferential side and an outer cell at an outer circumferential side as extending from the one end face to the other end face of the rotor; and
a groove portion concaved in a direction being apart from the rotor is formed at the exhaust side wall face as being overlapped with a trajectory of the partition member lined during rotation of the rotor as viewed from the axial direction.

2. The pressure wave supercharger according to claim 1,
wherein the groove portion is formed at the exhaust side wall face so that width thereof is equal to or larger than thickness of the partition member in the radial direction.

3. The pressure wave supercharger according to claim 1,
wherein the housing further includes an intake side wall face which is arranged at the accommodating room as being opposed to the other end face of the rotor and to which an intake air introduction port and an intake air discharge port communicating with an intake passage of the internal combustion engine are opened; and
an intake side groove portion concaved in a direction being apart from the rotor is formed at the intake side wall face as being overlapped with a trajectory of the partition member lined during rotation of the rotor as viewed from the axial direction.

4. The pressure wave supercharger according to claim 3,
wherein the intake side groove portion is formed at the intake side wall face so that width thereof is equal to or larger than thickness of the partition member in the radial direction.

5. A pressure wave supercharger comprising:
a housing including an accommodating room to accommodate a rotor rotatably about an axis, and an exhaust side wall face which is arranged at the accommodating room as being opposed to one end face of the rotor in the axial direction and to which an exhaust gas introduction port and an exhaust gas discharge port communicating with an exhaust passage of an internal combustion engine are opened;
wherein the rotor includes a shaft portion supported by the housing rotatably about the axis, plural partition walls arranged as being extended in the radial direction from the shaft portion and in the axial direction from the one end face to other end face of the rotor, and a partition member which is arranged at a space between mutually adjacent partition walls to partition the space into an inner cell at an inner circumferential side and an outer cell at an outer circumferential side; and
the partition member is disposed at the rotor so that an end thereof at the one end face side is arranged at a position being further apart from the exhaust side wall face than the one end face.

6. The pressure wave supercharger according to claim 5,
wherein the housing further includes an intake side wall face which is arranged at the accommodating room as being opposed to the other end face of the rotor and to which an intake air introduction port and an intake air discharge port communicating with an intake passage of the internal combustion engine are opened; and
the partition member is disposed so that an end thereof at the other end face side is arranged at a position being further apart from the intake side wall face than the other end face.

7. The pressure wave supercharger according to claim 2,
wherein the housing further includes an intake side wall face which is arranged at the accommodating room as being opposed to the other end face of the rotor and to which an intake air introduction port and an intake air discharge port communicating with an intake passage of the internal combustion engine are opened; and
an intake side groove portion concaved in a direction being apart from the rotor is formed at the intake side wall face as being overlapped with a trajectory of the partition member lined during rotation of the rotor as viewed from the axial direction.
